(19) United States
(12) Patent Application Publication
(10) Pub. No.: US 2011/0187947 A1
(43) Pub. Date: Aug. 4, 2011

(54) Detachable screen guard assembly

(76) Inventors: Tihomir Tsanev, (US); Maria Dimitrova Tsaneva, (US)

(21) Appl. No.: 12/698,117

(22) Filed: Feb. 1, 2010

(51) Int. Cl. H04N 5/64; B60R 1/06

(52) U.S. Cl. 348/841; 359/507; 348/E05.128

(57) ABSTRACT

A detachable screen guard assembly mounted on a screen frame of a monitor comprising a screen protector and a fastening apparatus. The screen protector is transparent and made of glass, acrylic, or plastic having excellent transparency.

The fastening apparatus includes at least one couple of a hooking member and a bracket member. The bracket member is mounted on the screen frame and the hooking member is mounted on the screen protector. The hooking member attaches mechanically to the bracket member. Because the hooking member can be disengaged from the bracket member, the screen protector can be detached from the screen frame to be cleaned or mounted on another monitor that has a bracket member installed.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates generally to screen protective devices and more particularly to a detachable screen guard assembly for protecting a screen and mounted on a screen frame of an image display device.

2. Description of the related art

A great majority of the increasingly popular flat-screen monitors and flat-screen televisions have substantially fragile screens that need to be protected from accidental damage. In addition to the propensity of the screen being damaged, a screen protective device may benefit a viewer by reducing glare and radiation emitted by the screen.

A conventional screen protective device on the market is a hanging-type screen protective glass or plastic that in some cases is strapped to a monitor. This type of device, when hanging on top of a frame of a monitor, produces an inharmonious appearance to the monitor. Moreover, the hanging-type screen protective device has high manufacturing cost that makes it unaffordable for many users.

There are a number of previously developed screen protective devices that do not solve all challenges posed by the broad use of such devices with an existing monitor. Since a screen protective device is generally targeted for use by a broad consumer base, the installation process should be easy to perform even by an unskilled individual. In addition, the screen protective device should be easily detachable for cleaning. Further, the screen protective device should fit a wide range of presently manufactured monitors and should have low manufacturing cost.

Another screen protective device on the market is a thin protective membrane made of acrylic that directly attaches to a screen of a monitor. This type of protective device provides limited protection since it cannot prevent damage in case of substantial impact. In addition, it is hard to install on large size screens.

To overcome the shortcomings, the present invention provides detachable screen guard assembly to mitigate and obviate the above mentioned drawbacks.

### SUMMARY OF THE INVENTION

The primary objective of the present invention is to provide a detachable screen guard assembly for protecting the screen of an existing monitor. The drawbacks in the prior art and the conventional screen protective devices are overcome by the present invention as described below.

To achieve the objective, a detachable screen guard assembly mounted on a screen frame of a monitor comprising a screen protector and a fastening apparatus. The screen protector is transparent and made of glass, acrylic, or plastic having excellent transparency.

The fastening apparatus includes at least one couple of a hooking member and a bracket member. The bracket member is mounted on the screen frame and the hooking member is mounted on the screen protector. The hooking member attaches mechanically to the bracket member. Because the hooking member can be disengaged from the bracket member, the screen protector can be detached from the screen frame to be cleaned or mounted on another monitor that has a bracket member installed.

The present invention can be manufactured cost efficiently and can easily be installed on a monitor by an unskilled individual. The detachable screen guard assembly conveniently attaches to a monitor completely protects the screen and keeps the monitor neat in appearance. Once installed, the fastening apparatus allows the screen protector to be detached from and position-adjusted with respect to the monitor. In addition, once installed on the monitor, the detachable screen guard assembly can easily be entirely removed without leaving marks or damaging the monitor.

Many other advantages and features of the present invention will become manifest to those versed in the art upon making reference to the detailed drawings in which a preferred structural embodiment incorporating the principles of the present invention is shown by way of illustrative example.

3

### BRIEF DESCRIPTION OF THE DRAWINGS

FIG. 1 is an operational front view of the detachable screen guard assembly mounted on a monitor.

FIG. 2 is a fragmentary detail view of the detachable screen guard assembly mounted on a monitor.

FIG. 3 is a side view of the detachable screen guard assembly temporary detached from a monitor on which it is installed.

FIG. 4 is an operational side view of the detachable screen guard assembly mounted on a monitor.

### DETAILED DESCRIPTION OF THE INVENTION

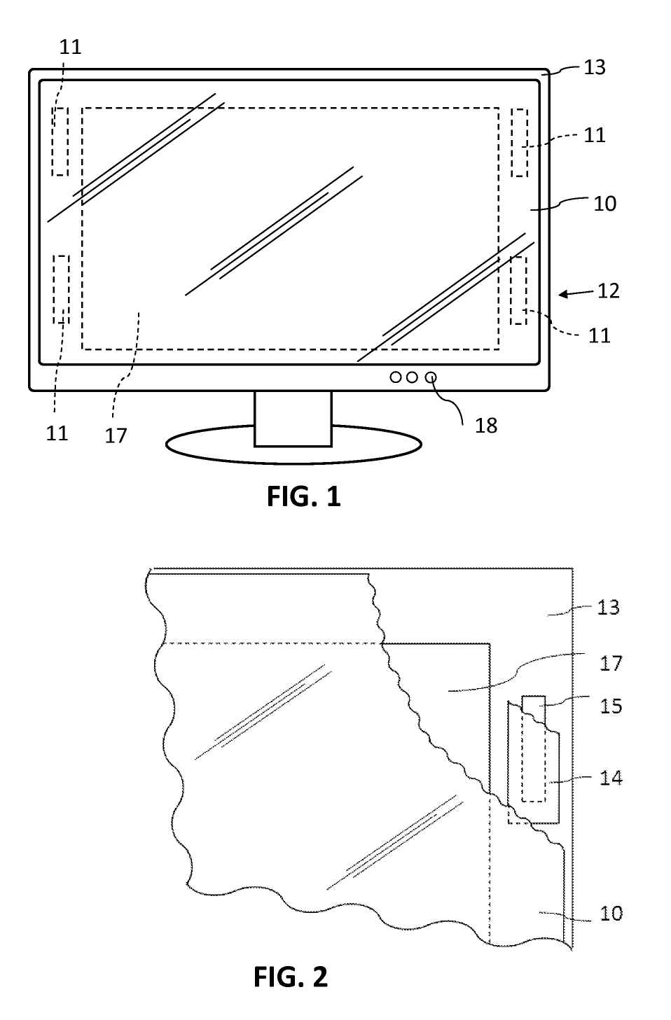

With reference to FIGS. 1 and 4, a detachable screen guard assembly in accordance with the present invention is mounted on a screen frame (13) of a monitor (12) to protect a screen (17) of the monitor (12) and has a screen protector (10) and a fastening apparatus (11).

The screen protector (10) is transparent and made of glass, acrylic, or plastic having excellent transparency. Preferably, the screen protector (10) further has anti-glare and anti-radiation efficiencies to reduce a potentially harmful radiation and make users feel comfortable when they use the monitor (12). It is to be understood that other materials may be used in so far as they provide easy viewing of the screen (17).

The screen protector (10) is mounted detachably in front of the monitor (12) and is constructed preferably in generally a rectangular shape. However, it is to be understood that such shape may be sized according to the shape and size of the monitor (12) on which it is to fit.

Additionally, the size of the screen protector (10) is ideally diminished to not cover parts of the monitor (12), and controlling buttons (18) when present on the front surface of the screen frame (13). Therefore, appearance of the monitor (12) is kept original and the controlling buttons (18) are operated as usual without obstruction.

Moreover, the screen protector (10) with the fastening apparatus (11) has a simple structure so that the manufacturing cost of the detachable screen guard assembly is decreased.

Further, in a preferred embodiment, the screen protector (10) has finished edges and rounded corners for improved appearance and to prevent injuries by accidental scraping or cutting of the user when working around the monitor. However, it is to be understood that such rounding of the corners of the screen protector (10) is for ergonomic reasons and that the corners may be shaped differently depending on various factors. In another embodiment (not shown), the screen protector (10) has a frame that improves appearance, holds the screen protector (10), or connects to the fastening apparatus (11).

The fastening apparatus (11) is mounted on the screen frame (13), detachably fastens the screen protector (10) in front of the monitor (12), and has one or multiple couples of a bracket member (15) and a corresponding detachable hooking member (14). With reference to FIG. 1, in the preferred embodiment, the fastening apparatus (11) comprises of four couples of the bracket member (15) and the hooking member (14). Moreover, the bracket member (15) and the hooking member (14) may be in different shapes and sizes, and may have different positioning on the screen frame (13) and the screen protector (10) respectively.

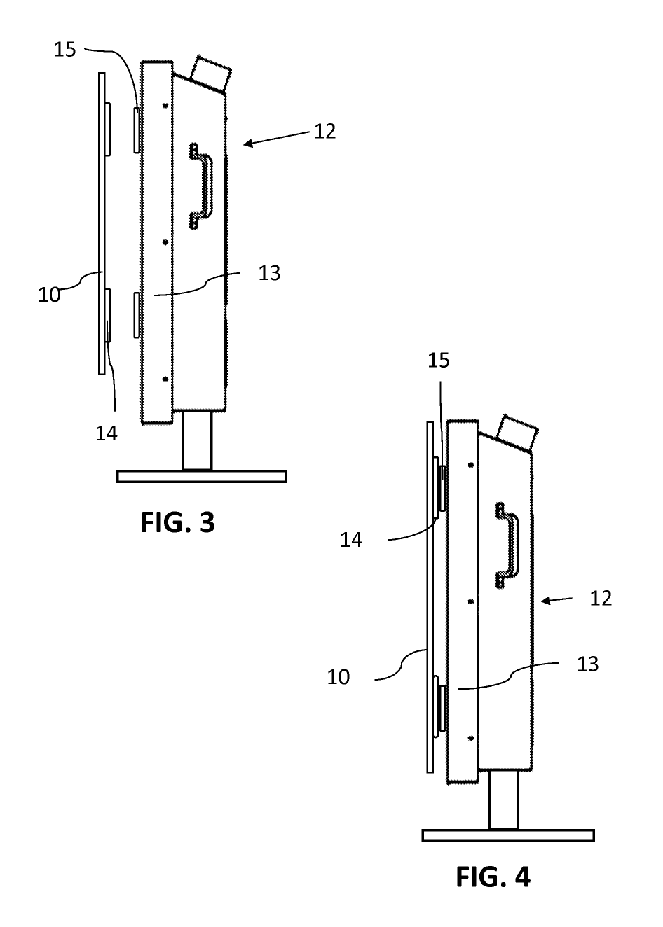

With reference to FIGS. 2, 3 and 4, the bracket member (15) is mounted on the surface of the screen frame (13) and has a front surface and a rear surface. The rear surface of the bracket member (15) connects to and is mounted on the surface of the screen frame (13) by removable adhesive tape. In addition, the bracket member (15) can be constructed such that it snaps on/off to the screen frame (13) or such that it is mounted on the surface of the screen frame (13) by glue or an adhesive tape. In the preferred embodiment, the bracket member (15) attaches to the screen frame (13) by easy to remove attachment strip that leaves no marks, such as 3M Command Adhesive Strips.

The hooking member (14) is mounted on the surface of the screen protector (10) and has a front surface and a rear surface. The rear surface of the hooking member (14) connects to and is mounted on the surface of the screen protector (10) by glue or an adhesive tape. In addition, the hooking member (14) can be constructed such that it is integrally connected to the screen protector (10), or such that it snaps on/off to the screen protector (10).

The front surface of the hooking member (14) and the front surface of the bracket member (15) are formed to be mechanically interlockable, whereby when the hooking member (14) and the bracket member (15) are interlocked the screen protector (10) is mounted on the monitor (12). Because the hooking member (14) is detachable from the bracket member (15), so the screen protector (10) can be detached from the screen frame (13). In addition, the hooking member (14) and the bracket member (15) can be constructed such that the hooking member (14) snaps on/off to the bracket member (15), or the hooking member (14) connects with the bracket member (15) through reclosable fastener, or other mechanical device.

When the detachable screen guard assembly is installed on the monitor (12), the fastening apparatus (11) allows the screen protector (10) to be adjusted horizontally and vertically with respect to the monitor (12) and the screen frame (13). With reference to FIG. 2, in the preferred embodiment, the hooking member (14) and the bracket member (15) attach together mechanically through reclosable fasteners. Further, the size of the hooking member (14) is larger than the size of the bracket member (15). Therefore, the hooking member (14) can be repositioned with respect to the bracket member (15), and thus the screen protector (10) can be adjusted with respect to monitor (12) and the screen frame (13).

The detachable screen guard assembly may be used on any suitable image display device, including but not limited, to rear projection display monitors, front projection display devices, flat screen televisions, various LCD, LTE and plasma displays. The monitor (12) may be constructed as a wall mounted or ceiling mounted monitor (not shown), or be constructed as a laptop or desktop computer monitor.

In the preferred embodiment, the color of the hooking member (14) approximately matches the color of the screen frame (13). In addition, in the preferred embodiment, the fastening apparatus (11) allows for approximately 3 millimeters gap between the screen frame (13) and the screen protector (10). The gap allows air to flow between the screen frame (13) and the screen protector (10) and thus prevents overheating of the screen (17). In another embodiment (not shown), paint or other means can be applied on the screen protector (10) to conceal the fastening apparatus (11) from a viewer.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

1. A detachable screen guard assembly adapted to be mounted on a screen frame of an image display device comprising:
a screen protector being optically transparent and physically rigid, sized to extend over a screen of the image display device;
a fastening apparatus adapted to be mounted on the screen frame of the image display device, detachably fastening the screen protector on the screen frame and having at least one couple of a bracket member and a detachable hooking member, wherein each one of the at least one bracket member has a front surface and a rear surface adapted to be connecting to and mounted on the screen frame; each one of the at least one detachable hooking member corresponds to and faces a corresponding said bracket member, has a front surface and a rear surface adapted to be connecting to and mounted on the screen protector; the front surface of the hooking member and the front surface of the bracket member are formed to be mechanically interlockable, whereby when the hooking member and the bracket member are interlocked the screen protector is mounted on the image display device; and the hooking member and the bracket member can be interlocked in more than one position with respect to each other, allowing the screen protector to be adjusted with respect to the image display device.

2. (canceled)

3. (canceled)

4. The detachable screen guard assembly of claim 1, wherein the screen protector has finished edges or rounded corners for improved appearance or to prevent injuries to the user.

5. (canceled)

6. The detachable screen guard assembly of claim 1, wherein said screen protector, when attached to said image display device, is distanced from the screen frame, whereby air can flow between the screen protector and the image display device.

7. The detachable screen guard assembly of claim 1, wherein said image display device is a flat screen television or a computer monitor.

8. (canceled)

9. The detachable screen guard assembly of claim 1, wherein said screen protector further has a frame.

10. The detachable screen guard assembly of claim 1, wherein said screen protector further has a means of concealing said fastening apparatus, whereby said fastening apparatus remains hidden from a viewer of the image display device.

11. The detachable screen guard assembly of claim 1, wherein said screen protector further has an anti-glare efficiency.

12. The detachable screen guard assembly of claim 1, wherein the screen protector has efficiency to protect a viewer from the radiation emitted by the image display device.

13. The detachable screen guard assembly of claim 1, wherein said detachable screen guard assembly is adapted to be removably attached to an image display device, whereby said detachable screen guard assembly can easily be entirely removed from the screen frame without leaving marks or causing damage.

14. The detachable screen guard assembly of claim 1, wherein each couple of the bracket member and the hooking member that is a part of the fastening apparatus comprises a reclosable fastener member mounted on the screen frame and adapted to mate with a second reclosable fastener member mounted on the screen protector.

15. The detachable screen guard assembly of claim 1, wherein the fastening apparatus is colored so that its color approximately matches the color of the screen frame.

16. The detachable screen guard assembly of claim 1, wherein the screen protector is made of acrylic or plastic.

17. The detachable screen guard assembly of claim 1, further including additional means of fastening to said image display device.

18. The detachable screen guard assembly of claim 1, wherein the screen protector and the fastening apparatus are decorated.

19. The detachable screen guard assembly of claim 1, wherein the screen protector shape is adjusted to better fit the display or provide access to display control means.

20. (canceled)

21. (canceled)

22. (canceled)

23. (canceled)

24. A detachable screen guard assembly adapted to be mounted on a screen frame of an image display device comprising:
a screen protector being optically transparent and physically rigid, sized to extend over a screen of the image display device;
a fastening apparatus adapted to be mounted on the screen frame of the image display device, detachably fastening the screen protector on the screen frame and having at least one couple of a bracket member and a detachable hooking member, wherein each one of the at least one bracket member has a front surface and a rear surface adapted to be connecting to and mounted on the screen frame by removable adhesive device, whereby said bracket member can easily be entirely removed from the screen frame without leaving marks or causing damage; each one of the at least one detachable hooking member corresponds to and faces a corresponding said bracket member, has a front surface and a rear surface adapted to be connecting to and mounted on the screen protector; the front surface of the hooking member and the front surface of the bracket member are formed to be mechanically interlockable, whereby when the hooking member and the bracket member are interlocked the screen protector is mounted on the image display device; and the hooking member and the bracket member can be interlocked in more than one position with respect to each other, allowing the screen protector to be adjusted with respect to the image display device.

25. A detachable screen guard assembly adapted to be mounted on a screen frame of an image display device comprising:
a screen protector being transparent and rigid, sized to extend over a screen of the image display device;
a removable fastening apparatus adapted to be mounted on the screen frame of the image display device, detachably and position adjustably fastening the screen protector on the screen frame and having at least two bracket members and detachable hooking members, wherein each one of the at least two bracket members have front surfaces and rear surfaces adapted to be connected to and mounted on the screen frame by position adjustable support, whereby said bracket member being removable from the screen frame; each one of the at least two detachable hooking members corresponds to and faces a corresponding said bracket member, has a front surface and a rear surface connecting to and mounted on the screen protector; the front surface of the hooking member and the front surface of the bracket member are formed to be detachable and position adjustable while connected, whereby when the hooking member and the bracket member being interlocked, the screen protector is mounted on the image display device; and the hooking member and the bracket member being connected and position adjustable relative to each other so that the screen protector is supported and adjustable to facilitate alignment relative to the screen frame of the image display device.
